(19) United States
(12) Patent Application Publication
(10) Pub. No.: US 2011/0069966 A1
(43) Pub. Date: Mar. 24, 2011

(54) OPTICAL TRANSCEIVER WITH ELECTRICAL DISPERSION EQUALIZATION

(75) Inventor: Takatoshi Kato, Yokohama-shi (JP)

(73) Assignee: SUMITOMO ELECTRIC INDUSTRIES, LTD., OSAKA (JP)

(21) Appl. No.: 12/881,493

(22) Filed: Sep. 14, 2010

(30) Foreign Application Priority Data
Sep. 24, 2009 (JP) 2009-219352

(51) Int. Cl. H04B 10/02

(52) U.S. Cl. 398/136

(57) ABSTRACT

An optical transceiver operable in multi transmission rates is disclosed. The optical transceiver includes an EDC to compensate the deformation appeared in the input signal due to the dispersion of the optical transmission line. The EDC operates as the transversal filter for higher transmission rates, while it operates as the low-pass-filter for lower transmission rates. In medium transmission rates, the EDC passes through the input signal.

### BACKGROUND OF THE INVENTION

1. Field of the Invention

The present invention relates to an electrical dispersion equalization applicable to an optical transceiver that receives and transmits optical signals, and to an optical transceiver implementing the same.

2. Related Background Art

An optical communication system, whose distance between the optical ports is less than a few kilo-meters and a transmission speed is less than a several hundreds of mega bit per second (Mbps) generally uses a multi-mode fiber for the transmission medium, a light-emitting diode (LED) for an optical signal source and a photodiode (PD) for a light-receiving device.

While, an optical communication system with the transmission speed of 2.5 Gbps, 10 Gbps or higher uses the single-mode fiber as a transmission medium and a laser diode (LD) as an optical signal source, which follows the international standard of, for instance, Synchronous Digital Hierarchy (SDH) and Synchronous Optical NETwork (SONET).

Recently, an optical communication system that combines a multimode fiber with an LD is directed to a higher transmission rate using a cost effective multi-mode fiber. However, because a core of the multimode fiber may propagate many modes each showing specific transmission speed, the optical signal to be transmitted in the multimode fiber is easily deformed, which makes it hard to transmit an optical signal in a higher transmission rate.

One solution has been suggested in the United State Patent Application published as US-2009/0041468A to compensate the signal deformation in the multimode fiber due to different transmission speed specific to the mode, in which the dispersion caused in the multimode fiber may be electrically compensated for an electrical signal converted from the received optical signal. This technique to compensate the dispersion electrically has been called as the Electronic Dispersion Compensator (EDC). The standard, IEEE 802.3aq, has ruled to use the EDC to realize the transmission rate of 10 Gbps for already installed multimode fiber.

FIG. 7 is a functional block diagram of an optical transceiver 1, while, FIG. 8 is a block diagram of an EDC implemented within the optical transceiver 1. The optical transceiver 1 shown in FIG. 7 comprises a transmitter unit 2 and a receiver unit 3. The transmitter unit 2 recovers an input electrical signal by a clock and data recovery (CDR) 4, drives a semiconductor laser diode (LD) based on the recovered electrical signal by an LD driver 5. The LD emits an optical signal modulated with the recovered electrical signal to an optical fiber, which is not illustrated in FIG. 7.

The receiver unit 3 includes a photodiode (PD) 7, a trans-impedance amplifier (TIA) 8, an EDC 9 and another CDR 10. The PD receives an optical signal from an optical fiber and generates a photocurrent. The TIA 8, which operates as a pre-amplifier, converts the photocurrent into a voltage signal. The EDC 9 electrically compensates the voltage signal, and the CDR 10 extracts a data and a clock contained in the compensated voltage signal.

The EDC 9, as shown in FIG. 8, is one type of digital filters, in particular, the EDC 9 shown in FIG. 8 is called as the transversal filter. The EDC 9 includes a delay unit 11, a multiplier 12 and an adder 13. The delay unit 11 includes a plurality of delay elements each delaying an input thereof by a period T and outputting thus delayed signal to the multiplier 12. The multiplier 12 also includes a plurality of multiplying units each multiplying the output of the delay unit with a tap coefficient. The adder 13 generates a sum of respective outputs of the multiplying unit 12. The EDC 9 further includes a smaller 14, a slicer 15, and an error detector 17. The sampler 14 samples the output of the adder 13 by a period of T, and holds the sampled signal with at least a period T. The slicer 15 compares the output of the sampler 14 with a preset reference to generate a binary signal. The input of the slicer 15, which is an analogue signal, and the output thereof, which is a binary signal, are compared and a difference therebetween is fed to the tap controller 16. The tap controller 16 adjusts the tap coefficients provided to respective multiplier units such that the output of the error detector 17 minimizes.

FIG. 8 is the functional block diagram of the EDC with the feedforward arrangement, but, another type of the EDC has been known as the feedback configuration.

The IEEE 802.3aq only defines the transmission rate of 10 Gbps, but other standards, such as those called as the fiber channel, has ruled the multi-transmission rates. Specifically, the FC-PI-4 (Fiber Channel Physical Interface) has ruled three transmission rates of 8.5 Gbps, 4.25 Gbps, and 2.125 Gbps, but has ruled that the EDC is necessary to be implemented only for the transmission rate 8.5 Gbps.

Because the EDC is necessary to set the unit delay T as a reciprocal of the transmission rate, namely, T equal to 100 ps for the transmission rate of 10 Gbps and so on. When the EDC is operated for multiple transmission rates but the single and permanent unit delay T, the EDC tends to cause an incorrect operation or to diverge the tap coefficients. Moreover, the optical transceiver operable in multi transmission modes is necessary to implement with devices responsible to a high transmission rates, that is, the devices are operable in a higher frequency. When such devices are used in relatively lower frequency, the noises with higher frequency components are amplified and generated by the devices, which degrades the optical sensitivity of the transceiver. For instance, the PD and the TIA operable for the transmission rate of 8.25 Gbps are used for the transmission rate of 4.25 Gbps; the optical sensitivity degrades by 3 dB because the frequency bandwidth of the devices is twice.

### SUMMARY OF THE INVENTION

An aspect of the present invention relates to an optical transceiver that comprises: a PD, a pre-amplifier, and an EDC. The optical transceiver of the invention may be operable for multi transmission rates. The PD receives an optical signal from a transmission optical fiber and generates a photocurrent corresponding to the optical signal. The pre-amplifier, which may be a type of trans-impedance amplifier, may convert the photocurrent into a voltage signal. The EDC receives the voltage signal provided from the pre-amplifier and generates a compensated signal. A feature of the present invention is that the EDC automatically adjusts the tap coefficients thereof for the first transmission rate, sets only one of the tap coefficients to be TRUE, while, the other of the tap coefficients to be FALSE for the second transmission rate slower than the first transmission rate, and fixes the tap coefficients to preset values for the third transmission rate slower than the second transmission rate.

The EDC of the present invention may operate as a transversal filter to compensate the input deformed signal for the first transmission rate, as a low-pass-filter to reduce noises with high frequency components generated in the PD and the pre-amplifier for the third transmission rate, and pass through the voltage signal provided from the pre-amplifier. Accordingly, the optical transceiver may be operable in multi transmission rate even the transceiver implements with the EDC.

### BRIEF DESCRIPTION OF THE DRAWINGS

The invention will be described in conjunction with the accompanying drawings, in which:

FIG. 1 is a functional block diagram of an optical transceiver according to an embodiment of the present invention;

FIG. 2 is a functional block diagram of an EDC according to an embodiment of the present invention;

FIGS. 3A and 3B are the functional block diagram of an optical transceiver according to another embodiment of the invention;

FIGS. 4A to 4C show eye diagrams of a signal input to the EDC for respective transmission rates;

FIGS. 5A to 5C show frequency responses of the EDC for respective transmission rates;

FIGS. 6A to 6C show eye diagrams of a signal output from the EDC for respective transmission rates;

FIG. 7 is a functional block diagram of a conventional optical transceiver; and

FIG. 8 is a functional block diagram of an EDC implemented within the conventional optical transceiver shown in FIG. 7.

### DETAILED DESCRIPTION OF PREFERRED EMBODIMENTS

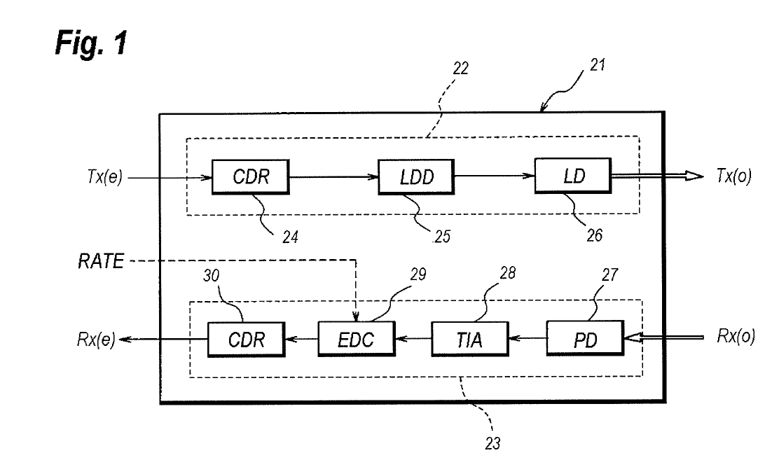

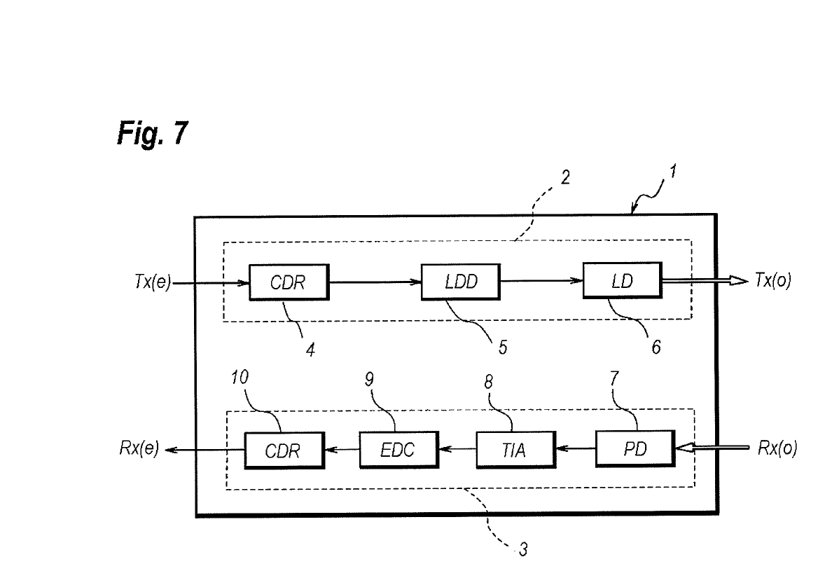

Next, preferred embodiments according to the present invention will be described as referring to accompanying drawings. FIG. 1 shows an optical transceiver according to an embodiment of the invention. The optical transceiver 21 shown in FIG. 1 comprises a transmitter section 22 and a receiver section 23 similar to the arrangement of a conventional optical transceiver shown in FIG. 7. The transmitter section 22 includes a clock and data recovery (CDR) 24, an LD-driver 25, and a semiconductor laser diode (hereinafter denoted as LD) 26. The CDR 24 reshapes and recovers the electrical data input to the optical transceiver 21. The LD-driver 25 drives the LD by the signal provided from the CDR 24. The LD 26 emits signal light which is modulated by the electrical signal recovered by the CDR 24.

The receiver section 23 includes a semiconductor photodiode (PD) 27, a pre-amplifier 28, an electrical dispersion correction (EDC) 29, and another CDR 30. The PD 27 generates a photocurrent by receiving signal light provided from the optical fiber. The pre-amplifier 28, which may be an arrangement of a trans-impedance amplifier (TIA), converts the photocurrent into a voltage signal. The EDC 29 electrically compensates the dispersion superposed in the voltage signal provided from the TIA 28. The CDR 30 reshapes and recovers the signal compensated by the EDC 29 and outputs thus reshaped electrical signal. A feature of the optical transceiver 21 according to the present embodiment is that the EDC 29 may vary or adjust the tap co-efficient thereof in the multiplier unit depending on the transmission rate, for instance 5 Gbps, 10 Gbps or 20 Gbps, the information of which is externally provided.

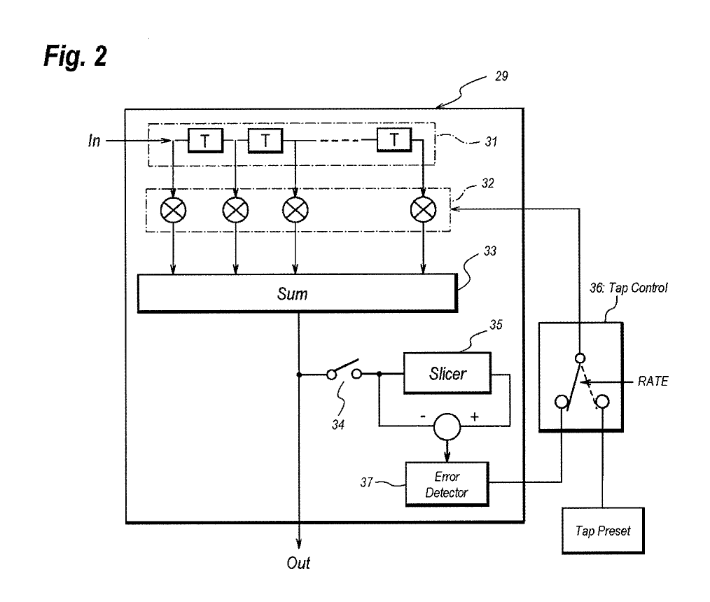

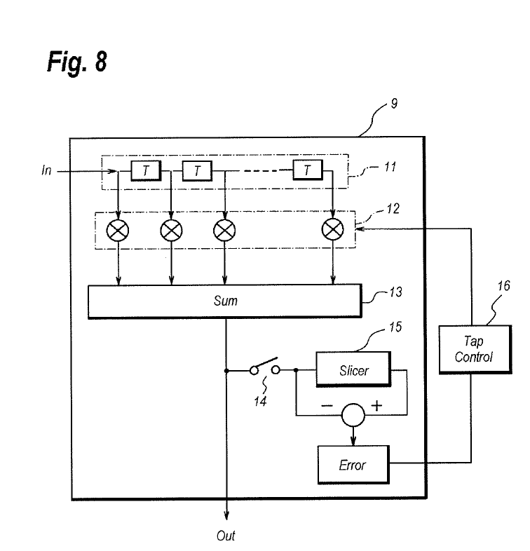

FIG. 2 shows an example of the EDC 29 with a function of the selectable tap co-efficient. The EDC 29 shown in FIG. 2, similar to the conventional EDC shown in FIG. 8, includes the input delay unit 31 with the transversal type, the multiplier unit 32, and the sum unit 33. The delay unit 31 includes a plurality of delay elements 31a each delaying the output of the upward delay element by a period T. The first delay element delays the input of the delay unit 31. The multiplier unit 32 multiplies respective outputs of the delay elements with the tap co-efficient specific to respective delay units. The sum unit 33 adds respective outputs of the multiplier unit 32 and outputs thus added result. The delay unit 31, the multiplier unit 32, and the sum unit 33 carry out function of the self-convolution.

The EDC 29 further includes sampler 34 which has a function of, what is called, the sample-and-hold for sampling the output provided from the sum unit 33 for a period T and holding the sampled output which is provided to the slicer 35. The slicer 35 has a function of the comparator where the input thereof, which is equivalent to the held output of the sampler 34, is compared with a preset reference and outputs a binary signal. The error detector 37 compares this binary output with the input of the slicer 35; namely, the analogue output of the slicer 34 and sends the compared results to the tap controller 36. The tap controller 36 adjusts the tap co-efficient provided to the multiplier 32 based on the output of the error detector 37 so as to minimize the output of the error detector 37.

A feature of the EDC 29 according to the present embodiment is that the tap controller 36 receives the RATE signal and adjusts the tap co-efficient depending on the RATE signal. Specifically, when the optical transceiver 21 is operated in a high speed mode, the EDC 29 adjusts the tap co-efficient by the feedback loop of the sum unit 33, the sampler 34, the slicer 35, the error detector 37 and the tap controller 36. While, the transceiver 21 operates in a relatively slow speed mode, the tap controller 36 switches the input thereof from the output of the error detector 37 to the preset 38 which provides the fixed tap coefficient. When the multiplier 32 is provided with the set of the fixed tap co-efficient, the EDC 29 operates as a transversal filter to pass only relatively lower frequency components. The EDC 29 operating as a transversal filter, noises of the PD 27 and the TIA 28, whose operable frequency bandwidths are set broader because they are necessary to respond higher frequencies and inevitably cause noises in high frequencies, may be reduced and the sensitivity of the receiver unit 23 may be enhanced.

Assuming cases where the transmission rates of the transceiver are 5 Gbps, 10 Gbps, and 20 Gbps, the delay time T of the delay unit 31 is 50 ps, and the frequency bandwidth of the PD 27 and that of the TIA 28 are 7.5 GHz applicable to the rate of 10 Gbps; the EDC 29 may compensate the deformation in the waveform due to not only the dispersion in the transmission line but the limited frequency bandwidth of the PD 27 and the TIA 28 by adjusting the tap coefficient. When the transmission speed is 10 Gbps where the PD 27 and the TIA 28 become adequately operable, the EDC 29 may set the tap coefficient such that only one of the tap coefficients is set to be TRUE “1”, while, the other tap coefficients are set to be FALSE “0”, which equivalently passes the EDC 29. Moreover, when the rate signal RATE indicates the transmission speed of 5 Gbps, the EDC 29 sets the tap coefficients such that the EDC 29 operates as an LPF (low-pass-filter) to eliminate the high frequency noise due to the PD 27 and the TIA 29.

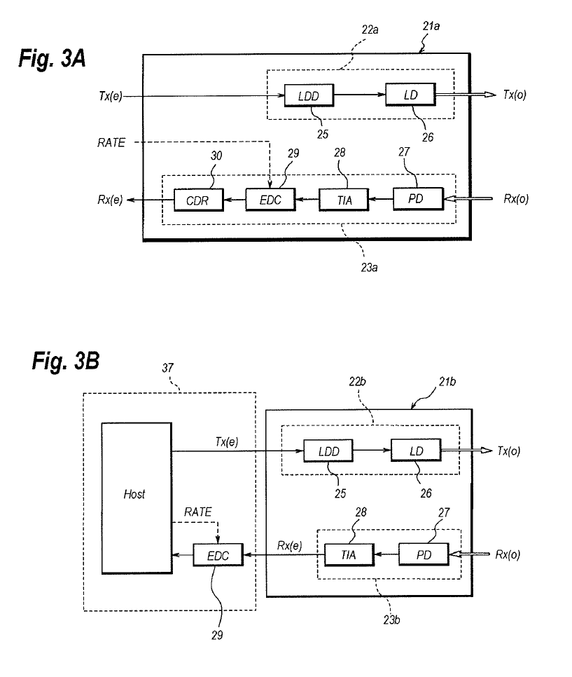

A feature of the present invention shown in FIGS. 1 and 2, and described above is applicable to another type of a transceiver whose block diagram is shown in FIGS. 3A and 3B. The optical transceiver 21a shown in FIG. 3A has the transmitter unit 22a including only the LD-driver 25 (LDD) and the LD 26, while, the receiver unit 23a has the same arrangement with those of the transceiver 21 shown in FIG. 1. The optical transceiver 21a in FIG. 3A eliminates the CDR in the transmitter unit 22a and the deformation appearing in the transmitter unit 22a may be compensated in the receiver unit 23a involved in the other optical transceiver optically coupled with the present transceiver 21a.

FIG. 3B shows a functional block diagram of the other type of the optical transceiver 21b according to an embodiment of the invention. The optical transceiver 21b shown in FIG. 3B comprises a transmitter unit 22b including the LD-driver 25 and the LD 26, and a receiver unit 23b that includes the PD 27 and the TIA 28. This optical transceiver 21b shown in FIG. 3B eliminates the EDC in the receiver unit 223b in addition to an EDC involved in the transmitter unit. However, the host system coupled with the optical transceiver 21b has the function of the CDR and implements with the EDC 29. Thus, the optical transceiver 21b includes only the PD 27 and the TIA 27 in the receiver unit 23b.

Next, some results according to the present invention will be described, in which the results assumes the following: three transmission rates, 5 Gbps, 10 Gbps, and 20 Gbps, are selected, the total bandwidth of the optical fiber, the PD and the TIA is 6 GHz, the EDC 29 has the configuration of only the feedforward arrangement without any feedback arrangement with seven (C0˜C6) controllable taps and the unit delay T of 50 ps.

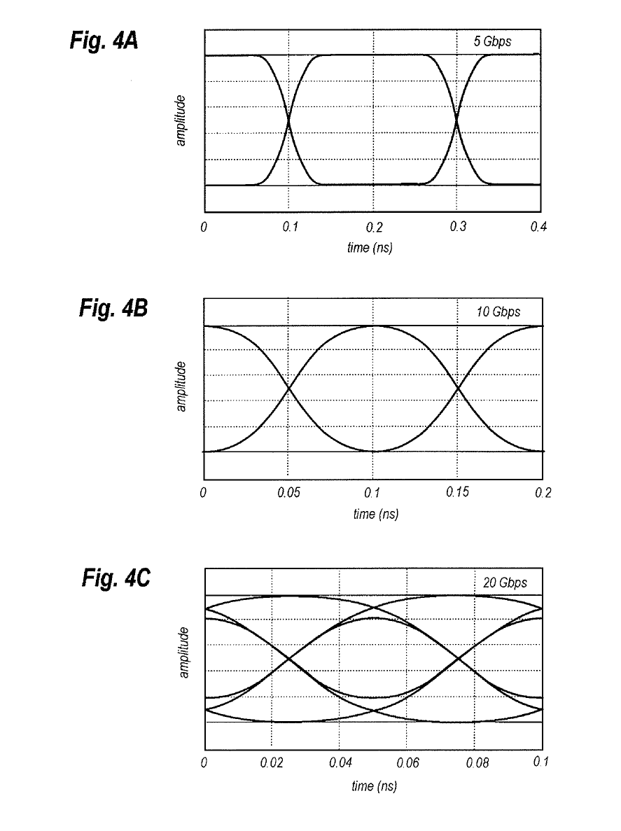

FIGS. 4A to 4C show eye diagrams of the signal input to the EDC 29 for the transmission rates of 5, 10, and 20 Gbps, respectively. The eye diagrams for 5 and 10 Gbps show an enough eye but the eye opening penalty was found to be 2.2 dB for the transmission rate of 20 Gbps due to the limited band width of the optical fiber, the PD 27 and the TIA 28.

When such deformed signal for the transmission rate of 20 Gbps is input to the EDC 29, the EDC 29 automatically adjusts the tap coefficients, CO to C6, thereof to be −0.014, 0.08, −0.487, 2.98, −0.729, 0.216 and −0.06, respectively. For the transmission rate of 10 Gbps, the EDC 29 sets TRUE only for the tap coefficient C3, while, sets FALSE for the other tap coefficients. Under such tap coefficients, the EDC 29 passes through the input signal only with a delay of 100 ps. Finally, for the transmission rate of 5 Gbps, the fixed tap coefficients of, C2=0.25, C3=0.5, C4=0.25, and the other coefficients, C0, C1, C5 and C6, are set to be zero (0), under which the EDC 29 operates as an LPF because the components multiplied by 0.25 superposed with the primary component multiplied with 0.5 by the unit delay of 50 ps.

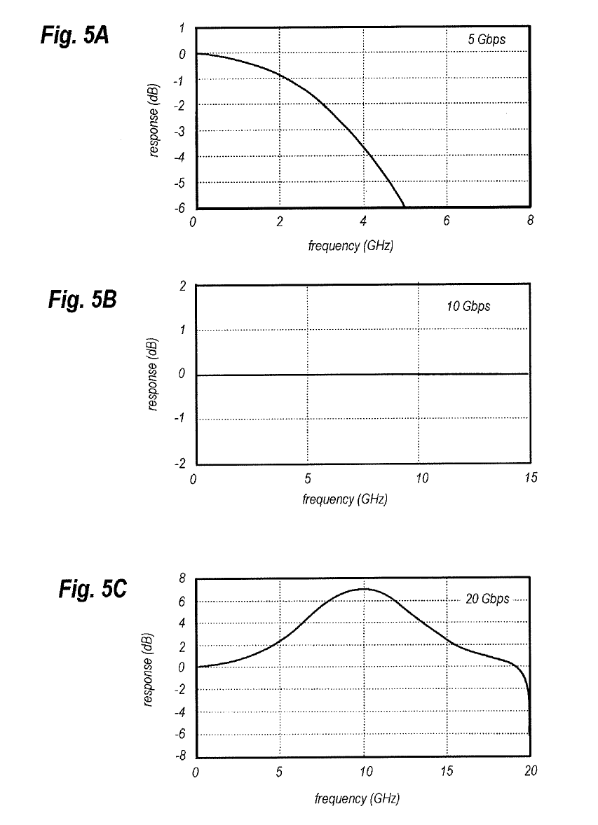

FIGS. 5A to 5C correspond to the response of the EDC 29 for respective transmission rates. As shown in FIG. 5A, the frequency response of the EDC 29 for the rate 5 Gbps shows the LPF performance with the cut off frequency of 3.6 GHz. For the transmission rate of 10 Gbps, the EDC 29 shows no frequency response, as shown in FIG. 5B. Further, the EDC 29 enhances the high frequency performance by showing a peak around 10 GHz to compensate the limited bandwidth of the other devices as shown in FIG. 5C.

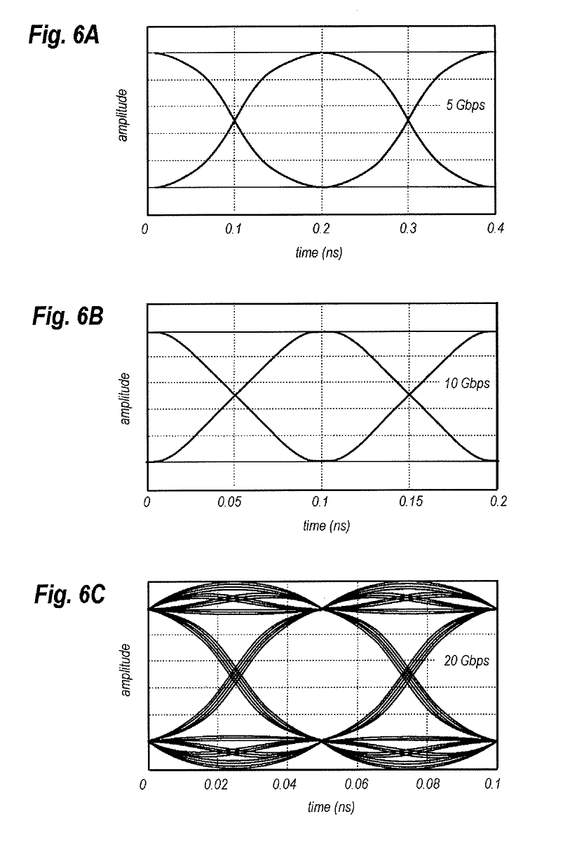

FIGS. 6A to 6C show the eye diagram output from the EDC 29 operated under the condition described above. For the transmission rate of 5 Gbps, the output shows an enough eye without deforming the input waveform shown in FIG. 4A. Because the EDC 29 operates as an LPF with the cut-off frequency of 3.6 GHz, the sensitivity of the receiver unit may be improved by about 2.2 dB. For the transmission rate of 10 Gbps, the output shows an enough eye, as shown in FIG. 6B. Finally, for the transmission rate of 20 Gbps shown in FIG. 6C, the output of the EDC 29 shows enough eye without penalty although some overshoots and undershoots are found.

Thus, the EDC according to the present invention may vary the tap control mode depending on the transmission rate; accordingly, the EDC may compensate the deformation appeared in the input signal for relatively higher transmission rate, while, the EDC may reduce the noise caused by the excess frequency bandwidth of the PD and the TIA for relatively lower transmission rate. The optical transceiver implementing with the EDC of the invention may enhance the optical sensitivity for the lower transmission rate, and may securely recover the transmitted optical signal for the higher transmission rate.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

I claim:

1. An optical transceiver operable for multi transmission rates, comprising:
a photodiode configured to receive an optical signal from a transmission optical fiber and to generate a photocurrent corresponding to said optical signal;
a pre-amplifier configured to convert said photocurrent into a voltage signal; and
an EDC circuit configured to receive said voltage signal and to generate a compensated signal,
wherein said EDC automatically adjusts tap coefficients thereof for a first transmission rate, sets only one of said tap coefficients to be TRUE while other of tap coefficients to be FALSE in a second transmission rate slower than said first transmission rate, and fixes said tap coefficients to preset values for a third transmission rate slower than said second transmission rate.

2. The optical transceiver of claim 1,
wherein said EDC operates as a transversal filter performing a self-convolution function.

3. The optical transceiver of claim 1,
wherein said EDC operates as a low-pass-filter for said third transmission rate.

4. The optical transceiver of claim 1,
wherein said EDC passes through said voltage signal for said second transmission rate.

5. The optical transceiver of claim 1,
wherein said transceiver receives a rate select signal from an outside of said transceiver.

6. The optical transceiver of claim 1,
further comprising a CDR configured to receive said compensated signal and to output data extracted from said compensated signal.

7. The optical transceiver of claim 1,
wherein said first transmission rate is greater than 10 Gbps.

8. The optical transceiver of claim 1,
wherein said third transmission rate is less than 10 Gbps.
